(19) United States
(12) Patent Application Publication
(10) Pub. No.: US 2016/0364176 A1
(43) Pub. Date: Dec. 15, 2016

(54) Method for Storing Data and Device Thereof

(71) Applicants: Beijing Lenovo Software Ltd., Beijing (CN); Lenovo (Beijing) Co., Ltd., Beijing (CN)

(72) Inventor: Qingtao SUN, Beijing (CN)

(73) Assignees: Beijing Lenovo Software Ltd., Beijing (CN); Lenovo (Beijing) Co., Ltd., Beijing (CN)

(21) Appl. No.: 14/854,942

(22) Filed: Sep. 15, 2015

(30) Foreign Application Priority Data
Jun. 12, 2015 (CN) 201510324643.6

(51) Int. Cl. G06F 3/06

(52) U.S. Cl. CPC G06F 3/0649; G06F 3/0619; G06F 3/0679

(57) ABSTRACT

A method and device for storing data are provided. In the method, first characteristic information of target data to be processed is obtained, where the first characteristic information is used to represent a predicted frequency at which the target data is accessed after the target data is saved in a storage unit; a target storage block is chosen from storage blocks in the storage unit, based on the first characteristic information of the target data; and then the target data is saved in the target storage block.

### CROSS REFERENCE OF RELATED APPLICATION

The present application claims the priority to Chinese Patent Application No. 201510324643.6, titled “METHOD FOR STORING DATA AND DEVICE THEREOF”, filed on Jun. 12, 2015 with the State Intellectual Property Office of People's Republic of China, which is incorporated herein by reference in its entirety.

### TECHNICAL FIELD

The disclosure relates to the field of information processing technology, and in particular to a method for storing data and a device thereof.

### BACKGROUND

Solid state disk (SSD) is widely applied in electronic devices such as notebook and desktop computer due to features such as high read and write speed and low power consumption. SSD consists of a control unit and a storage unit, and it is quite common that SSD adopts nand flash memory as the storage unit. However, the nand flash memory has limited service life, thus affects the usage life of SSD.

### SUMMARY

In view of this, a method for storing data and a device thereof are provided in the disclosure, which are advantageous for improving service life of the solid state disk.

In one aspect, in a method for storing data, first characteristic information of target data to be processed is obtained, where the first characteristic information is used to represent a predicted frequency at which the target data is accessed after the target data is saved in a storage unit; a target storage block is chosen from the storage unit, based on the first characteristic information of the target data; and then the target data is saved in the target storage block.

In another aspect, a device for storing data is provided. The device includes: a first characteristic obtaining unit, configured to obtain first characteristic information of target data to be processed, wherein the first characteristic information is used to represent a the predicted frequency at which the target data is accessed after the target data is saved in a storage unit; a storage block determining unit, configured to choose a target storage block from the storage unit based on the first characteristic information of the target data; and a storage unit, configured to save the target data in the target storage block.

### BRIEF DESCRIPTION OF THE DRAWINGS

In order to illustrate the technical solutions according to the embodiments of the disclosure more clearly, the drawings to be used in the description of the embodiments are described briefly hereinafter. Apparently, the drawings described hereinafter are just embodiments of the disclosure, other drawings may be obtained by those skilled in the art according to those drawings without creative effort.

FIG. 1 shows a flow diagram of a method for storing data according to an embodiment of the disclosure;

FIG. 2 shows a flow diagram of a method for storing data according to another embodiment of the disclosure;

FIG. 3 shows a flow diagram of a method for storing data according to yet another embodiment of the disclosure;

FIG. 4 shows a structure diagram of a device for storing data according to an embodiment of the disclosure; and

FIG. 5 shows a structure diagram of a device for storing data according to another embodiment of the disclosure.

### DETAILED DESCRIPTION OF THE EMBODIMENTS

The technical solution according to the embodiments of the disclosure will be described clearly and completely in conjunction with the drawings hereinafter. Apparently, the described embodiments are just a few rather than all of the embodiments of the disclosure. All other embodiments obtained by those skilled in the art based on the embodiments of the disclosure without any creative work will fall within the protection scope of the disclosure.

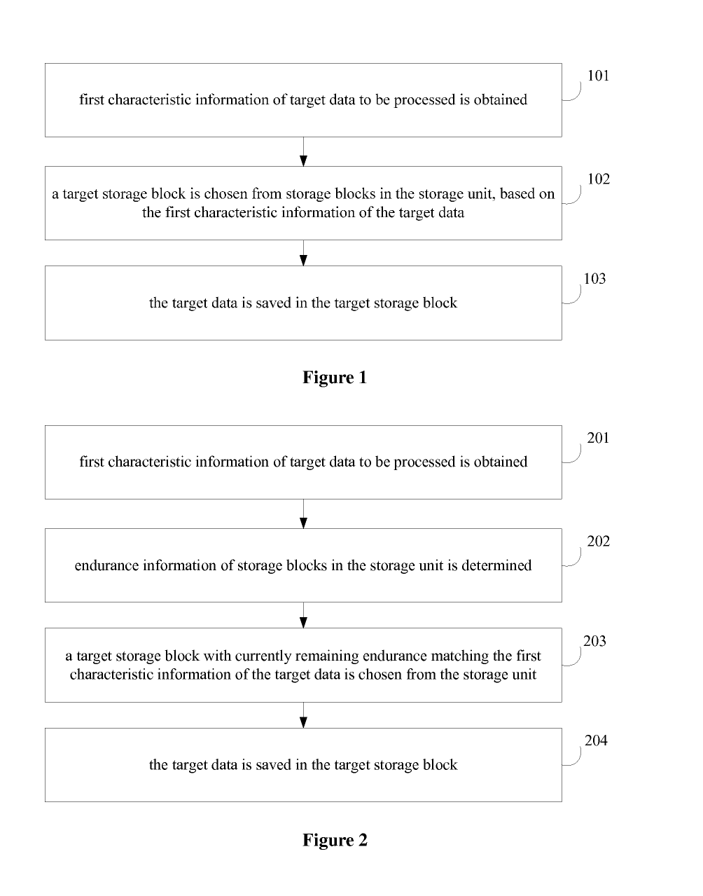

Referring to FIG. 1, a flow diagram of a method for storing data according to an embodiment of the disclosure is shown. The method may include steps 101-103.

In step 101, first characteristic information of target data to be processed is obtained.

The first characteristic information is used to represent a predicted frequency at which the target data is accessed after the target data is saved in a storage unit.

It may be understood that, after data is saved in the storage unit, if the data is accessed at a high frequency, the storage unit is frequently read and written, thus usage life of the storage unit is affected.

In step 102, a target storage block is chosen from storage blocks in the storage unit, based on the first characteristic information of the target data.

It may be understood that, there may be one or more pieces of target data to be processed, such as one data packet or more data packets. For any piece of target data, in case of large volume of the target data, a plurality of target storage blocks may be determined for storing the target data.

According to the embodiment of the disclosure, the data block for storing the target data is not selected aimlessly and randomly, but is selected with comprehensive consideration of information about the frequency at which the target data is accessed after the target data is stored, thus it is advantageous to choose the storage block suitable for storing the target data in terms of overall losses of the storage unit.

In step 103, the target data is saved in the target storage block.

According to the embodiment of the disclosure, it is needed to obtain the first characteristic information of the target data before storing the target data. Since the first characteristic information represents the predicted frequency at which the target data would be accessed after being stored, a possible life loss after the target data is saved in the storage unit may be predicted, thus choosing the storage block for storing the target data based on the first characteristic information is advantageous for alleviating an imbalance in the service life of the storage blocks and improving the service life of the solid state disk.

It may be understood that, according to the embodiment of the disclosure, the storage unit may be interpreted as the storage unit in the solid state disk SSD, such as nand flash memory in SSD; or be interpreted as storage units in other types of storage mediums.

Referring to FIG. 2, a flow diagram of a method for storing data according to another embodiment of the disclosure is shown. The method may include steps 201-204.

In step 201, first characteristic information of target data to be processed is obtained.

The first characteristic information is used to represent a predicted frequency at which the target data is accessed after the target data is saved in a storage unit.

In step 202, endurance information of storage blocks in the storage unit is determined.

The endurance information represents currently remaining endurance of the storage block.

In step 203, a target storage block with currently remaining endurance matching the first characteristic information of the target data is chosen from the storage unit.

The main factor affecting the usage life of the storage unit is the endurance of respective storage blocks in the storage unit, thus the endurance of the storage blocks shortens with increase of number of data writing times. In a case that the endurance of the storage block is less than a preset value or equals zero, the storage block becomes unavailable, and one or more unavailable storage blocks may lead to an entire unavailable storage unit. Thus, in the embodiment, the target storage block for storing the target data is chosen based on the first characteristic information of the target data and the currently remaining endurance of the storage block.

Optionally, choosing the target data may include choosing one or more target storage blocks which have storage space capable of accommodating data volume of the target data and have currently remaining endurance matching the predicted frequency.

In step 204, the target data is saved in the target storage block.

According to the embodiment of the disclosure, the target storage block for storing the target data is chosen based on the currently remaining endurance of respective storage blocks in the storage unit and the effect on the endurance of storage blocks due to the storing of the target data, thus the target storage block is chosen reasonably, which is advantageous for the balance in service life of respective storage blocks in the storage unit.

It may be understood that, according to the embodiment of the disclosure, there are multiple ways for determining the target storage block matching the first characteristic information.

For example, a matching rule between the currently remaining endurance and the predicted frequency in the first characteristic information may be preset. In a case that the predicted frequency in the first characteristic information is greater than a first preset value, the endurance of the target storage block is greater than a first preset number of times; in a case that the predicted frequency in second characteristic information is less than a second preset value, the currently remaining endurance of the target storage block is less than a second preset number of times; and in a case that the predicted frequency in the first characteristic information ranges between the first preset value and the second preset value, the target storage block with endurance greater than the second preset value but less than the first preset value may be chosen. The first preset value is greater than the second preset value, and the first preset number of times is greater than the second preset number of times.

As another example, it may be preset that, if the predicted frequency in the first characteristic information is greater than a first threshold, the respective storage blocks in the storage unit are sorted in a diminishing sequence in terms of the currently remaining available endurance, and the storage block with the highest available endurance is chosen as the target storage block; in a case that the predicted frequency in the first characteristic information is less than a second threshold, the respective storage blocks in the storage unit are sorted in a diminishing sequence in terms of the currently remaining available endurance, and the storage block with the lowest available endurance is chosen as the target storage block; and in a case that the predicted frequency in the first characteristic information ranges between the first threshold and the second threshold, the respective storage blocks in the storage unit are sorted in a diminishing sequence in terms of the currently remaining available endurance, and the storage block with available endurance in the middle of the sequence is chosen as the target storage block. For example, it may be set that, the storage block with available endurance ranging from the 10^{th} to the 20^{th} in the sequence is chosen to store the target data with predicted frequency ranging between the first threshold and the second threshold.

As yet another example, a rule may be preset that, the higher the predicted frequency of target data stored is, the larger the available endurance of the storage block for storing the target data is. The target storage block corresponding to the target data to be processed is determined based on the preset rule.

It may be understood that, in any of the embodiments, there are multiple possibilities for the target data to be processed.

For example, when target data to be saved in the storage unit is received, the data to be stored is the target data to be processed.

In a case that the target data to be processed is the data to be stored, determining the target storage block in the storage unit may include determining the target storage block for storing the target data to be stored among idle storage blocks in the storage unit. Specifically, when it is needed to determine the currently remaining endurance of the storage block, in the embodiment it is feasible to only determine the available endurance information of the idle storage blocks in the storage unit. Accordingly, the target storage block with currently remaining available endurance matching the first characteristic information of the target data to be stored may be determined among the idle storage blocks. For specific matching modes, relative introduction in forgoing embodiments may be referred to, which is not repeated herein.

As another example, the target data to be processed may be the target data which is already stored in the storage block of the storage unit and has the predicted frequency mismatching the endurance information of the storage block. The process of determining the target data may include: determining the storage block to be adjusted for which the currently remaining endurance does not match the predicted frequency of data stored in the storage block to be adjusted, among storage blocks in the storage unit which have already stored data; and determining the target data stored in the storage block to be adjusted. There may be one or more storage blocks to be adjusted.

It may be understood that, in practice, with variation of the access frequency of data stored in respective storage blocks of the storage unit, the currently remaining available endurance information of respective storage blocks may varies accordingly. Thus it is possible that some data with low access frequency is stored in the storage block with large available endurance, which leads to an imbalance in service life of respective storage blocks. Thus the data stored in respective storage blocks of the storage unit may be adjusted regularly. Accordingly, after the storage block to be adjusted and the target data stored in the storage block to be adjusted are determined, for any piece of target data, the target storage block for storing the target data is chosen among the storage block to be adjusted and/or empty storage blocks based on the first characteristic information of the target data; and the target data is transferred from the storage block to be adjusted to the target storage blocks.

An example is described for better understanding. The storage unit includes 5 storage blocks, which are referred to as storage block A, storage block B, storage block C, storage block D and storage block E respectively. The current available endurance information of the five storage blocks are a thousand times, six thousand times, two thousand and five hundred times, five thousand times and eight thousand times respectively, where target data A is stored in storage block A, target data B is stored in storage block B, and no data is stored in storage block C, storage block D and storage block E. Supposing that the predicted access frequency of target data A is 100 times per second, and the access frequency of target data B is 10 times per second, it may be seen that the access frequency of target data A is higher, but the available endurance of storage block A storing the target data A is the lowest; accordingly, the access frequency of target data B is lower, but the available endurance of storage block B is slightly higher, thus storage block A and storage block B are both storage blocks to be adjusted.

A target data adjusting mode may include transferring target data A in storage block A to storage block B for storing, and transferring target data B from storage block B to storage block A.

Another target data adjusting mode may include choosing the storage block with the highest endurance in the storage unit to store the target data A, i.e., transferring target data A from storage block A to storage block E; and meanwhile, transferring target data B in storage block B to storage block A for storing.

Other target data adjusting modes may also be applicable to the embodiment, which are not described herein.

It should be noted that, the embodiment is illustrated through the example that the target data is saved in one storage block. It may be understood that, in a case that the target data has a large data volume that can not be accommodated in the storage space of one storage block and it is needed to store the target data in a plurality of storage blocks, it may be needed to determine a plurality of target storage blocks when transferring the target data, and the process is the same as that of transferring or storing the target data to one storage block.

Optionally, in the embodiments, when receiving first target data to be stored and the first characteristic information of the first target data, the determining of the storage block to be adjusted, for which the currently remaining endurance does not match the predicted frequency of data stored in the storage block to be adjusted, may be triggered, and when determining the target storage block for storing the first target data, the target storage block to which second target data stored in the storage block to be adjusted needs to be transferred simultaneously.

Optionally, for determining the storage block to be adjusted, the storage block to be adjusted, for which the currently remaining endurance does not match the predicted frequency of data stored in the storage block to be adjusted, may be determined when it is detected that a preset data adjusting condition is met at current moment, among storage blocks in the storage unit which have already stored data; where the preset data adjusting condition may be receiving of a specific instruction, or may be that a data adjusting period is preset and the current moment is a preset data adjusting moment.

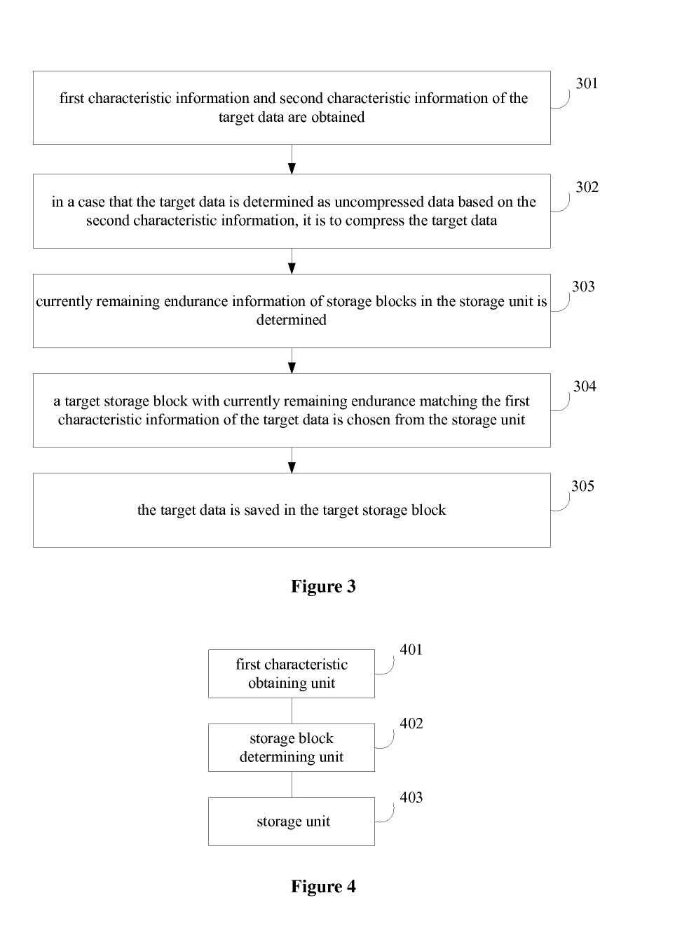

Referring to FIG. 3, a flow diagram of a method for storing data according to yet another embodiment of the disclosure is shown. The method may include steps 301-305.

In step 301, first characteristic information and second characteristic information of the target data are obtained.

The second characteristic information is used to represent a current compression state of the target data. The compression state identifies whether the current target data is compressed data or uncompressed data.

In step 302, in a case that the target data is determined as uncompressed data based on the second characteristic information, it is to compress the target data.

According to the embodiment, it is needed to transfer the target data to a compression unit of the solid state disk for compression only in a case that the target data is determined as uncompressed data based on the second characteristic information, then a target storage block of the storage unit is determined, and the compressed target data is transferred to the target storage block for storage.

If the target data is compressed data, the target data is directly transferred to the determined target storage block without being transferred to the compression unit for compression, thus a data process load for a controller such as solid state disk is avoided, power consumption is reduced and data storage rate is improved.

In step 303, currently remaining endurance information of storage blocks in the storage unit is determined.

The endurance information represents the currently remaining endurance of the storage block.

In step 304, a target storage block with currently remaining endurance matching the first characteristic information of the target data is chosen from the storage unit.

In step 305, the target data is saved in the target storage block.

In any of the embodiments, the first characteristic information or the second characteristic information of the target data to be processed may be determined through an operating system, thus the first characteristic information or the second characteristic information of the target data transferred from the operating system may be received, or the first characteristic information or the second characteristic information of the target data may be requested from the operating system.

The first characteristic information is determined by the operating system based on an amount of accesses to the target data per unit time; or is determined by the operating system based on a data type of the target data, e.g., in a case that the target data has not been stored before, the frequency at which the target data is accessed cannot be determined, hence the possible frequency at which the target data is accessed may be determined based on the data type of the target data.

The operating system may analyze the compression state of the data, thus the compression state of the target data may be determined based on the operating system directly, and the controller of the solid state disk does not need to perform analysis and compression through the compression unit.

In another aspect, according to a method for storing data, a device for storing data is further provided in the application. Referring to FIG. 4, a structure diagram of a device for storing data according to an embodiment of the disclosure is shown. The device may include a first characteristic obtaining unit, a storage block determining unit and a storage unit.

The first characteristic obtaining unit 401 is configured to obtain the first characteristic information of the target data to be processed, and the first characteristic information is used to represent a predicted frequency at which the target data is accessed.

The storage block determining unit 402 is configured to choose the target storage block from storage blocks in the storage unit based on the first characteristic information of the target data;

The storage unit 403 is configured to store the target data in the target storage block.

According to the embodiment of the disclosure, it is needed to obtain the first characteristic information of the target data before storing the target data. Since the first characteristic information represents the predicted frequency at which the target data is accessed after the target data is stored, a possible life loss after the target data is saved in the storage unit may be predicted, thus choosing the storage block for storing the target data based on the first characteristic information is advantageous for alleviating an imbalance in service life of the storage blocks, and improving the service life of the solid state disk.

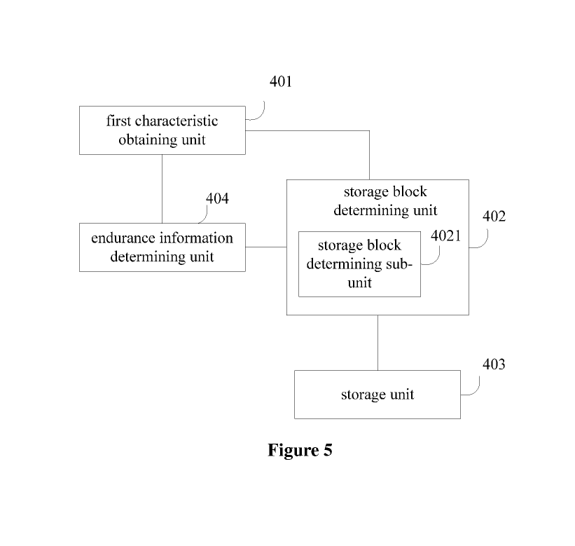

Referring to FIG. 5, a structure diagram of a device for storing data according to another embodiment of the disclosure is shown. The embodiment differs from the forgoing device embodiment as follows.

The device according to the embodiment may further include an endurance information determining unit 404.

The endurance information determining unit 404 is configured to determine, before the storage block determining unit determines the target storage block, endurance information of storage blocks in the storage unit, where the endurance information represents the currently remaining endurance of the storage block.

In this case, the storage block determining unit 402 include a storage block determining sub-unit 4021.

The storage block determining sub-unit 4021 is configured to choose from the storage unit the target storage block with the currently remaining endurance matching the first characteristic information of the target data.

According to any of the device embodiments, there are a plurality of cases for determining the target data and the first characteristic information.

Optionally, corresponding to one case, the first characteristic obtaining unit may include:

a first obtaining sub-unit configured to obtain the first characteristic information of the target data to be stored.

Further, in a case that the device includes the endurance information determining unit, the endurance information determining unit may include a first endurance information determining sub-unit.

The first endurance information determining sub-unit is configured to determine the endurance information of idle storage blocks in the storage unit.

Accordingly, the storage block determining unit may be configured to determine, among idle storage blocks in the storage unit, the target storage block with currently remaining endurance information matching the first characteristic information, for storing the target data.

Optionally, corresponding to another case of determining the target data and the first characteristic information, the device may further include an adjusting-block determining unit.

The adjusting-block determining unit is configured to, before the first characteristic obtaining unit obtains the first characteristic information, determine the storage block to be adjusted for which the currently remaining endurance does not match the predicted frequency of data stored in the storage block to be adjusted, among storage blocks in the storage unit which have already stored data.

In this case, the first characteristic obtaining unit includes a second obtaining sub-unit.

The second obtaining sub-unit is configured to determine the target data stored in the storage block to be adjusted, and obtain the first characteristic information of the target data.

In this case, the storage block determining unit includes a storage block determining sub-unit.

The storage block determining sub-unit is configured to, for any piece of target data, choose, among the storage block to be adjusted and/or empty storage blocks, the target storage block for storing the target data, based on the first characteristic information of the target data.

In this case, the storage unit includes a storage sub-unit.

The storage sub-unit is configured to transfer the target data from the storage block to be adjusted to the target storage block.

Further, based on the embodiment, the adjusting-block determining unit may include:

a first adjusting-block determining unit, configured to, once receiving first target data to be stored and the first characteristic information of the first target data, determine the storage block to be adjusted for which the currently remaining endurance does not match the predicted frequency of data stored in the storage block to be adjusted, among storage blocks in the storage unit which have already stored data;

or, a second adjusting-block determining unit, configured to, once it is detected that a preset data adjusting condition is met at a current moment, determine the storage block to be adjusted for which the currently remaining endurance does not match the predicted frequency of data stored in the storage block to be adjusted among storage blocks in the storage unit which have already stored data.

Accordingly, the second obtaining unit includes a second obtaining sub-unit.

The second obtaining sub-unit is configured to obtain second target data stored in the storage block to be adjusted and the first characteristic information of the second target data.

Optionally, in the embodiments, in a case that the device includes the storage block determining sub-unit, the storage block determining sub-unit may be configured to, based on predicted frequency of the target data, choose from the storage unit one or more target storage blocks which have storage space capable of accommodating data volume of the target data and have currently remaining endurance matching the predicted frequency.

Optionally, based on any one of the embodiments, the device further include:

a second characteristic obtaining unit, configured to obtain second characteristic information of the target data when the first characteristic obtaining unit obtains the first characteristic information of the target data to be processed, where the second characteristic information is used to represent a current compression state of the target data; and

a compression unit, configured to, before the storage block determining unit determines the target storage block, compress the target data in a case that the target data is determined as uncompressed data based on the second characteristic information.

In the embodiments, the device may further include a characteristic receiving unit.

The characteristic receiving unit is configured to receive the first characteristic information or the second characteristic information of the target data transferred by the operating system, where the first characteristic information is determined by the operating system based on an amount of accesses to the target data per unit time, or is determined by the operating system based on a data type of the target data.

The embodiments of the disclosure are described in a progressive manner, each embodiment focuses on the difference from other embodiments, and for the same or similar part, the embodiments may refer to each other. The apparatus embodiments may correspond to the method embodiments, thus description is brief, and for relevance, the method part may be referred to.

The forgoing description of the embodiments of the disclosure, is to allow those skilled in the art to implement or use the disclosure. A variety of modifications to the embodiments are apparent for those skilled in the art, and the general principles defined in the disclosure may be implemented in other embodiments without departing from the spirit and scope of the disclosure. Hence, the disclosure is not restricted to the embodiments shown in the disclosure, but conforms to a widest scope consistent with the principles and novel features in the disclosure.

What is claimed is:

1. A method for storing data, comprising:
obtaining first characteristic information of target data to be processed, wherein the first characteristic information is used to represent a predicted frequency at which the target data is accessed after the target data is saved in a storage unit;
choosing a target storage block from the storage unit, based on the first characteristic information of the target data; and
saving the target data in the target storage block.

2. The method according to claim 1, before choosing the target storage block from the storage blocks in the storage unit based on the first characteristic information of the target data, further comprising:
determining endurance information of the storage blocks in the storage unit, wherein the endurance information represents currently remaining endurance of the storage blocks;
wherein the choosing the target storage block from storage blocks in the storage unit based on the first characteristic information of the target data comprises:
choosing from the storage unit the target storage block with currently remaining endurance matching the first characteristic information of the target data.

3. The method according to claim 1, wherein obtaining the first characteristic information of the target data to be processed comprises:
obtaining the first characteristic information of target data to be stored.

4. The method according to claim 2, wherein:
determining the endurance information of storage blocks in the storage unit comprises:
determining endurance information of idle storage blocks in the storage unit; and
choosing the target storage block from storage blocks in the storage unit comprises:
determining the target storage block with currently remaining endurance information matching the first characteristic information among the idle storage blocks in the storage unit, for storing the target data.

5. The method according to claim 2, before obtaining the first characteristic information of the target data to be processed, further comprising:
determining, a storage block to be adjusted for which the currently remaining endurance does not match the predicted frequency of data stored in the storage block to be adjusted, among storage blocks in the storage unit which have already stored data;
wherein the obtaining the first characteristic information of the target data to be processed comprises:
determining the target data stored in the storage block to be adjusted, and obtaining the first characteristic information of the target data;
wherein the choosing the target storage block from storage blocks in the storage unit based on the first characteristic information of the target data comprises:
for any piece of target data, choosing, among the storage block to be adjusted and/or empty storage blocks, the target storage block for storing the target data, based on the first characteristic information of the target data; and
wherein the saving the target data in the target storage block comprises:
transferring the target data from the storage block to be adjusted to the target storage block.

6. The method according to claim 5, wherein:
determining the storage block to be adjusted for which the currently remaining endurance does not match the predicted frequency of data stored in the storage block to be adjusted comprises:
once receiving first target data to be stored and the first characteristic information of the first target data, determining the storage block to be adjusted for which the currently remaining endurance does not match the predicted frequency of data stored in the storage block to be adjusted, among storage blocks in the storage unit which have already stored data; or
once it is detected that a preset data adjusting condition is met at a current moment, determining the storage block to be adjusted for which the currently remaining endurance does not match the predicted frequency of data stored in the storage block to be adjusted, among storage blocks in the storage unit which have already stored data; and
obtaining the first characteristic information of the target data to be processed comprises:
obtaining second target data stored in the storage block to be adjusted.

7. The method according to claim 2, wherein choosing from the storage unit the target storage block with currently remaining endurance matching the first characteristic information of the target data comprises:
choosing one or more target storage blocks which have storage space capable of accommodating data volume of the target data and have currently remaining endurance matching the predicted frequency.

8. The method according to claim 1, wherein when obtaining the first characteristic information of the target data to be processed, the method further comprises:
obtaining second characteristic information of the target data, wherein the second characteristic information is used to represent a current compression state of the target data; and
before choosing the target storage block from the storage blocks in the storage unit based on the first characteristic information of the target data, the method further comprises:
compressing the target data, in a case that the target data is determined as uncompressed data based on the second characteristic information.

9. The method according to claim 1, wherein obtaining the first characteristic information or the second characteristic information of target data to be processed comprises:
receiving the first characteristic information or the second characteristic information of the target data transferred from the operating system, wherein the first characteristic information is determined by the operating system based on an amount of accesses to the target data per unit time, or is determined by the operating system based on a data type of the target data.

10. A device for storing data, comprising:
a first characteristic obtaining unit, configured to obtain first characteristic information of target data to be processed, wherein the first characteristic information is used to represent a predicted frequency at which the target data is accessed after the target data is saved in a storage unit;
a storage block determining unit, configured to choose a target storage block from the storage unit based on the first characteristic information of the target data; and
a storage unit, configured to save the target data in the target storage block.

11. The device according to claim 10, further comprising:
an endurance information determining unit, configured to determine, before the storage block determining unit determines the target storage block, endurance information of the storage blocks in the storage unit, wherein the endurance information represents currently remaining endurance of the storage blocks;
wherein the storage block determining unit comprises:
a storage block determining sub-unit, configured to choose from the storage unit the target storage block with the currently remaining endurance matching the first characteristic information of the target data.

12. The device according to claim 11, wherein the first characteristic obtaining unit comprises:
a first obtaining sub-unit, configured to obtain the first characteristic information of the target data to be stored.

13. The device according to claim 11, further comprising:
an adjusting-block determining unit, configured to, before the first characteristic obtaining unit obtains the first characteristic information, determine a storage block to be adjusted for which the currently remaining endurance does not match the predicted frequency of data stored in the storage block to be adjusted, among storage blocks in the storage unit which have already stored data;
wherein the first characteristic obtaining unit comprises:
a second obtaining sub-unit, configured to determine the target data stored in the storage block to be adjusted, and obtain the first characteristic information of the target data;
wherein the storage block determining unit comprises:
a storage block determining sub-unit, configured to, for any piece of target data, choose, among the storage block to be adjusted and/or empty storage blocks, the target storage block for storing the target data, based on the first characteristic information of the target data; and
wherein the storage unit comprises:
a storage sub-unit, configured to transfer the target data from the storage block to be adjusted to the target storage block.

14. The device according to claim 13, wherein the adjusting-block determining unit comprises:
a first adjusting-block determining unit, configured to, once receiving first target data to be stored and the first characteristic information of the first target data, determine the storage block to be adjusted for which the currently remaining endurance does not match the predicted frequency of data stored in the storage block to be adjusted, among storage blocks in the storage unit which have already stored data; or
a second adjusting-block determining unit, configured to, once it is detected that a preset data adjusting condition is met at a current moment, determine the storage block to be adjusted for which the currently remaining endurance does not match the predicted frequency of data stored in the storage block to be adjusted among storage blocks in the storage unit which have already stored data; and
wherein the second obtaining unit comprises:
a second obtaining sub-unit, configured to obtain second target data stored in the storage block to be adjusted and the first characteristic information of the second target data.

15. The device according to claim 10, further comprising:
a second characteristic obtaining unit, configured to obtain second characteristic information of the target data when the first characteristic obtaining unit obtains the first characteristic information of the target data to be processed, wherein the second characteristic information is used to represent a current compression state of the target data; and
a compression unit, configured to, before the storage block determining unit determines the target storage block, compress the target data in a case that the target data is determined as uncompressed data based on the second characteristic information.

16. The device according to claim 10, further comprising:
a characteristic receiving unit, configured to receive the first characteristic information or the second characteristic information of the target data transferred from the operating system, wherein the first characteristic information is determined by the operating system based on an amount of accesses to the target data per unit time, or is determined by the operating system based on a data type of the target data.
